(19) United States
(12) Patent Application Publication
(10) Pub. No.: US 2023/0294300 A1
(43) Pub. Date: Sep. 21, 2023

(54) Diffractive Visual-Tactile Sensing in Robotic Grippers

(71) Applicant: ABB Schweiz AG, Baden (CH)

(72) Inventor: Nolan W. Nicholas, West Lafayette, IN (US)

(73) Assignee: ABB Schweiz AG, Baden (CH)

(21) Appl. No.: 18/018,784

(22) PCT Filed: Jul. 30, 2020
(86) PCT No.: PCT/US2020/044226

§ 371 Date: Jan. 30, 2023

(51) Int. Cl. B25J 13/08; B25J 19/02

(52) U.S. Cl. CPC B25J 13/084; B25J 19/021; B25J 15/08

(57) ABSTRACT

A visual-tactile sensing device includes a visual-tactile sensing pad useful to capture image data related to a work piece during contact with the pad and as it approaches the pad. The sensing device can be used as part of a robotic gripper or other device. One or more lights can be used to illuminate the work piece and/or project light through the pad. The pad includes a rigid base, an elastic layer structured to deform upon contact with the work piece, and a diffraction layer structured to diffract light at different colors depending on the angle of the incoming light rays and camera placement.

### TECHNICAL FIELD

The present disclosure generally relates to visual-tactile sensing, and more particularly, but not exclusively, to robotic grippers that incorporate diffractive visual-tactile sensing.

### BACKGROUND

Providing tactile information of a work piece derived from image data generated with a tactile sensing pad along with proximity information of a work piece prior to engagement with the pad remains an area of interest. Some existing systems have various shortcomings relative to certain applications. Accordingly, there remains a need for further contributions in this area of technology.

### SUMMARY

One embodiment of the present disclosure is a unique diffractive visual-tactile sensing pad for robot grippers functioning as end effectors for robots. Other embodiments include apparatuses, systems, devices, hardware, methods, and combinations for determining visual-tactile information and proximity of work piece to a sensing device using light diffraction and colorimetric information produced thereby. Further embodiments, forms, features, aspects, benefits, and advantages of the present application shall become apparent from the description and figures provided herewith.

### BRIEF DESCRIPTION OF THE FIGURES

FIG. 1 depicts an embodiment of a visual-tactile sensing device in proximity to a work piece.

FIG. 2 depicts an embodiment of a diffractive visual-tactile contact pad with a lighting system and camera.

FIG. 3 depicts another embodiment of the lighting system for the diffractive visual-tactile contact pad.

FIG. 4 depicts another embodiment of a diffractive visual-tactile contact pad with a lighting system and camera.

FIG. 5 depicts another embodiment of a diffractive visual-tactile contact pad with a lighting system and camera.

FIG. 6 depicts another embodiment of a diffractive visual-tactile contact pad with a lighting system and camera.

FIG. 7 depicts one embodiment of the diffractive elements of the diffraction layer of the diffractive visual-tactile contact pad of FIG. 6.

FIG. 8 depicts another embodiment of a diffractive visual-tactile contact pad with a lighting system and camera.

FIGS. 9A-9C depict a method for gripping a work piece with the embodiment of FIG. 8.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

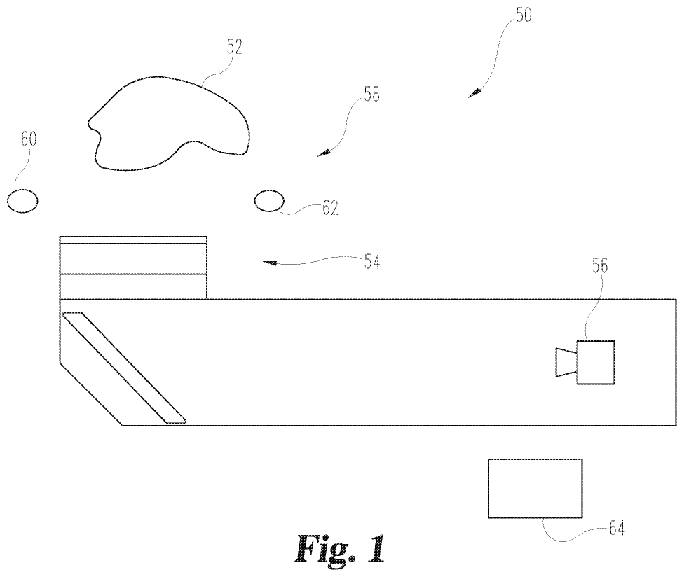

With reference to FIG. 1, a visual-tactile sensing device 50 is illustrated that is operable for sensing a work piece 52 as a robot gripper or other end effector approaches and eventually contacts the work piece 52 with a visual-tactile contact pad 54 of the device 50. The visual-tactile contact pad 54 is made of a number of pliable layers which deform when contacted under force by the work piece 52. Deformation of the pad 54 causes a change in color of the light received by the camera 56 from the diffraction elements within the pad 54 which can be sensed by the camera 56. In addition, deformation of the pad 54 shifts the position of the diffraction elements which can be observed as apparent lateral shifts of the position diffraction elements. Changes in shape as the diffraction elements are stretched and/or rotated and vertical shifts can also be observed as apparent changes in size/focal quality of the diffraction element. This information, among others, can be employed with the change in color by the visual-tactile sensing device 50 to determine information about the work piece 52.

Aiding the camera in detecting light color changes is a lighting system 58 which in the illustrated embodiment includes a first light source 60 and a second light source 62, but will be understood to include any different number of light sources. Although the camera 56 is depicted as being displaced from the pad 54 it will be appreciated that it can be placed in other locations. Further, the lights of the lighting system 58 are shown as being displaced to the side of the pad 54 and/or imaging scene of the camera 56, but other locations are also contemplated herein.

A controller 64 can be included to regulate actions of the lighting system 58, the camera 56, and/or a device or robot used to change position or orientation of the work piece 52 and/or pad 54. For example, in some forms the visual-tactile sensing device 50 can be incorporated into a robotic system in which a gripper, or any type of end effector, is formed or fabricated to include the pad 54. The controller 64 can alternatively and/or additionally be used to estimate contours of the work piece 52 and/or forces used to impress the work piece into the pad 54. Embodiments will be described below with respect to the pad 54 and various different characteristics, but it will be appreciated that all can be incorporated into the embodiments discussed with respect to FIG. 1.

In more specific details, the present application provides for the use of a tactile sensor possessing a deformable surface structure where the deformation of the surface structure by contacting objects may be imaged by a proximate camera and where images may also be obtained through this surface structure to observe objects and features which are not in contact with the surface layer. Typically the deformable surface structure (e.g. the pad 54) will be substantially transparent and the pad 54 will possess one or more markers or elements which are diffractive so that colorimetric features that vary based on the angle of the diffracted light may be imaged directly without complication from unknown optical characteristics to assess the shape of this surface layer. This provides the system the ability to both sense objects in contact with the sensing surface and forces resulting therefrom and also the ability to sense objects and features that are beyond the surface of the sensor body. This enables enhanced sensing for applications such as robotic manipulation, metrology, and surface measurement and characterization.

In the embodiments disclosed herein a sensor can be constructed utilizing a layer of deformable material possessing individual markers possessing colorimetric features that vary with the angle formed by the rays of the incoming light and placement of the camera. When objects (e.g. the work piece 52) come into contact with the top of the pad 54, it causes deformation to the deformable material containing the markers of the pad 54, causing angular changes in the diffracted light and resulting color variation, which is in turn imaged by the camera 56 and lighting system 58. The diffracted light produces colorimetric features that vary based on the parameters, such as surface shape and/or contours of the work piece 52, both in direct contact with pad 54 and beyond pad 54, and these parameters are imaged using transmitted and diffracted light. Deformable materials include various materials such as are known in the art including siloxanes such as PDMS, soft polyurethanes, etc.

The performance of the pad 54 to control optical properties which diffracted light captured by the camera 56 enable the computer imaging system (e.g. the controller 64) to more effectively image and calculate the geometric features and other parameters corresponding to the surface deformation. In the present application the colorimetric features of the diffracted light are combined with other optical parameters to report on the surface deformation of pad 54 to provide combined information assessments.

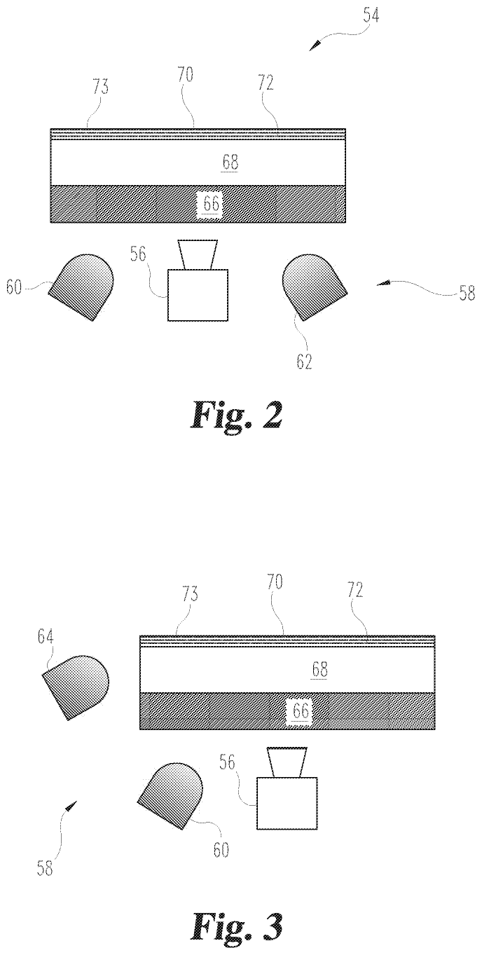

Turning now to FIG. 2, the visual-tactile contact pad 54 may be constructed in such a way that certain wavelengths of light are diffracted at different angles of the contact pad 54 surface relative to the angle of camera 56. Embodiments disclosed herein include a rigid base 66, elastic layer 68, and diffraction layer 70. Diffraction layer 70 may be provided as a separate layer of elastic material having one or more diffraction elements embedded therein. Diffraction layer 70 may also be provided as a complete plane or sheet of diffractive material in other embodiments.

Although the camera 56 in FIG. 2 is shown oriented to capture a direct image of the pad 54, other embodiments can include the camera 56 displaced relative to the pad 54 and may be provided an image through reflective techniques (e.g. mirrors) or through a fiber optic cable. Such variations also apply to all other embodiments disclosed herein. As will be understood, the term “camera” can refer to a variety of devices capable of detecting electromagnetic radiation and colorimetric features of diffracted light, whether in the visible range, infrared range, etc. Such “cameras” can also refer to 2D and/or 3D cameras.

In one or more of the embodiments herein tactile sensing by sensing device 50 can be created through a variety of mechanisms. For instance, individual diffraction markers 72 can be embedded in a layer of the pad 54 so that colorimetric features of the individual diffraction markers 72 vary with the angle of the rays of the incoming light from lights 60, 62 and/or camera 56. The diffraction markers 72 may possess diffractive elements, such as small areas or regions of holographic foil in circular shapes or other predetermined shapes. The deformation field of the surface of the elastic layer 68 can be more accurately assessed by visual methods by analyzing the apparent color of the marker(s) 72 along with other visual parameters associated with marker(s) 72, including one or more of its apparent position, apparent size, apparent shape, and apparent focal quality, for example.

The diffraction markers 72 can be incorporated into a diffraction layer 70 at the top of the elastic layer 68 of pad 54 in order to protect the markers 72 and prevent them from being damaged or removed from the elastic layer 68. For example, the diffraction markers 72 may be embedded in a thin diffraction layer 70 comprised of elastic material that is supported by a primary, thicker elastic layer 68 of elastic material, which is supported on a rigid transparent base 66. In some embodiments, the diffraction markers 72 can be constructed as relatively small flakes of diffractive material. The small size of the diffractive material comprising the flakes enables the flakes to act as markers to report on surface deformation of pad 54 while minimally impacting the dynamics of the surface deformation due to differential mechanical properties of the flakes relative to the elastic layer 68.

In certain embodiments, one or more of the diffraction markers 72 is comprised of holographic foil flakes having a circular shape to report on the surface deformation features and/or characteristics of pad 54. In some embodiments, the flakes can be provided with diameters as small 10 micrometers. In other embodiments, the flakes can be provided with diameters as small as 3 micrometers. The flakes may be constructed as diffractive reflectors where the diffraction is produced by features which are located in a plane of the surface of the flake extending along the contact surface 73 of pad 54. In another embodiment, one or more markers 72 can be provided as one or more particles with one or more flakes affixed to a side of the particle so that the diffraction is produced by features arranged or constructed normal to the surface of the marker 72 and/or the contact surface 73 of contact pad 54. For example, the markers can be arranged or constructed to produce diffraction by metal flakes with a Bragg-type dielectric stack on top of the elastic layer 68, such as Xirallic type particles affixed to metal flakes on one side.

In some embodiments the lighting supplied by lighting system 58 can take the form of a spectral continuum. In some alternative embodiments, the lighting supplied by lighting system 58 may take the form of a set of discrete spectral features. In some embodiments the lighting supplied by lighting system 58 may take a geometric form to control the angular distribution of light which is incident on the diffractive features. For instance, the lighting may be provided as a single point-like light source located at a particular point, or an annulus-shaped light-source, or as a substantially collimated lighting source.

In some embodiments, multiple independent lighting sources such as lights 60, 62 may be supplied which may be used to provide independent illumination controlled to occur in time sequence to be able to obtain colorimetric information relating to the surface deformation under various surface conditions. In certain embodiments, the color-shift as a function of angle will be chosen to match the anticipated angular deformation of the tactile sensor 50 and the lighting supplied, such as shown for light 64 in FIG. 3.

In the illustrated embodiment the rigid base 66 takes the form of a hard, transparent plate of polycarbonate which supports the elastic layer 68. The rigid base 66 can take other forms as will be appreciated. The elastic layer 68 takes the form of a deformable film of polydimethylsiloxane (PDMS). The elastic layer 68 can support the diffraction layer 70. In one form the base 66, elastic layer 68, and diffraction layer 70 substantially allow at least some light to pass through this stack so that light reaching the camera 56 substantially corresponds to light that has passed through the stack of layers and carries information about objects beyond the pad 54. In this way the work piece 52 can be imaged as it approaches, but not yet touching, the visual-tactile contact pad 54.

FIGS. 2 and 3 also disclose multiple lights 60, 62 that are provided to aid in illumination of the work piece 52 and pad 54. As will be appreciated given the discussion above, the lights can be housed within the device 50. In some cases these lights may be configured in different positions to provide different lighting conditions for imaging the tactile surface and objects 52 beyond the tactile surface, such as shown with light 64 in FIG. 3. In some cases these lights may be disposed to provide lighting from opposite sides of the camera 56 as shown in FIG. 2 so that the structure of illuminated and darkened regions (shadows) provides further information on the surface deformation.

The lights 60, 62 can be placed any distance away from one another and at any spacing suitable relative to the viewing window of the camera 56. The lights 60, 62 can be arranged to project toward each other. The projection can, but need not, be at common angles. The lights can, but need not, project common intensity (lumens). The lights can, but need not, project at common wavelengths. Any variation of the above parameters (orientation, angles, lumens, wavelengths) are contemplated herein.

In some cases these lighting conditions are provided as a sequential series of illumination (e.g. blinking) provided from alternating lights 60, 62 so that multiple lighting conditions can be utilized to maximize the processable information and the camera 56 can obtain distinguishing light information in both spectral and temporal channels. Thus, the lights 60, 62 can be activated in an ON-OFF sequence which, in some forms, are coordinated with each other. To set forth just one non-limiting example, a first light 60 can be activated to the ON condition while the second light 62 is deactivated to the OFF condition, whereupon after an interval of time (which can be predetermined or determined as a result of system processing) the condition reversed with the first light 60 deactivated to OFF while the second light 62 is activated to ON. The above-described process can be repeated with the same or different interval. Such alternating can be sequences which results in a blinkering of lights 60, 62.

The lighting system 58 (either a single light source or multiple light sources 60, 62) can be structured to emit light (electromagnetic radiation) at a range of wavelengths. As used herein the term “emit” or “emitting” or “emanate” or “emanating” is used to describe a process by which a material can either reflect light produced from another source, can produce light itself (e.g. infrared radiation if heated), or can be excited to produce light (e.g. fluorescence). To set forth just one example, a light 60, 62 can be structured to emit light at wavelengths visible to a human eye (e.g. “visible light”), at infrared or near-infrared wavelengths, a combination of the same, or any other suitable wavelength(s). In some forms the lighting system 58 can include a single light source capable of emitting any of the aforementioned wavelengths and/or ranges. In other forms multiple light sources can be used to emit light at any of the aforementioned wavelengths and/or ranges (which sources can emit at the same wavelengths and/or ranges or can overlap in at least some of the wavelengths and/or ranges). In some forms the lighting system 58 can include an artificial light directly coupled with the imaging system described herein, as well as ambient sunlight, or any other source of light that may not be directly coupled to the imaging system described herein.

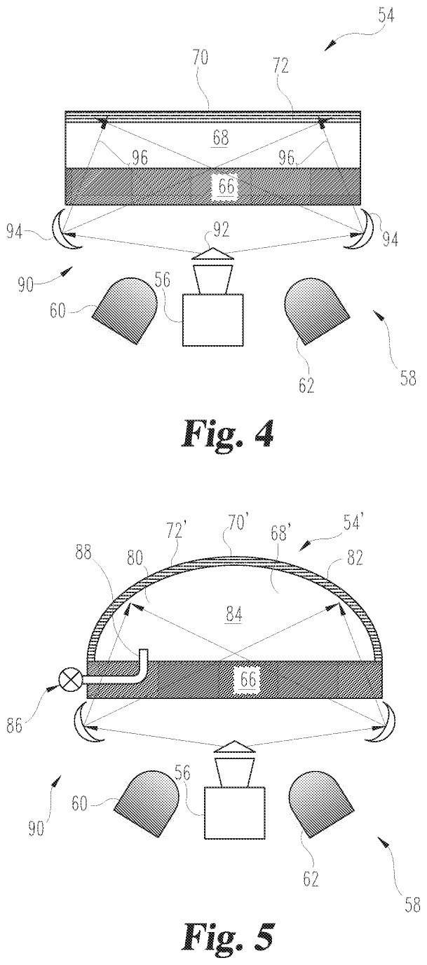

Referring to FIG. 4, an embodiment is illustrated that includes an optical system 90. Optical system 90 is configured for use with camera 56 to provide a plurality of viewing angles for obtaining colorimetric information from the diffracted light produced by contact pad 54. The optical system 90 is configured to project multiple views onto different portions of the camera imaging surface of pad 54 sensed by camera 56 to provide enhanced performance for measuring optically detected tactile sensing properties. In particular, the optical system 90 provides for measurement of diffraction color from multiple angles and/or views of the visual field.

As discussed above, tactile sensing is achieved through the use of individual diffraction markers 72, which are configured to possess colorimetric features that vary with the angle formed by the rays of the incoming light and placement of one or more cameras 56. The optical information accessed from markers 72 is assessed from a multiplicity of effective viewing angles provided by optical system 90.

In the illustrated embodiment, optical system 90 includes components that project multiple views onto diffraction layer 70 so that multiple viewing angles may be achieved with a single camera 56. For example, optical system 90 may include an optical element 92 and one or more mirrors 94 each arranged to provide different viewing angles 96 to diffraction layer 70. Optical element 92 may include, for example, two or more discrete parts which allow optical information to be projected from discrete optical systems, such as a mirror system, to be separately projected onto the camera 56. Embodiments may include an inverted triangular mirror surface, for example. Other embodiments may employ multiple cameras 56 to provide differently oriented viewing angles.

Referring to FIG. 5, another embodiment visual-tactile contact pad 54′ is shown that can be used with a jamming gripper. In a jamming gripper the individual fingers of the end effector are replaced by a single mass of material that flows around and conforms to the shape of the work piece 52 when pressed against it. A vacuum is then applied to pinch the contact pad 54′ to hold the work piece 52.

Visual contact pad 54′ can be employed with tactile-optical system 90 to provide multiple views of the diffraction layer 70′ and work piece 52 to obtain higher fidelity and resolution of the topographical information for the gripped work piece 52 and resulting shape of the contact pad 54′. As discussed above, a single camera 56 may be used in which multiple views are projected onto diffraction layer 70′ using optical system 90. Alternatively or additionally, multiple cameras 56 may be employed. Lighting system 58 includes one or more lights 60, 62 for illumination and characteristic determination of the work piece 52.

The contact pad 54′ includes an elastic layer 68′ in which viewing angles are changeable dynamically by retracting the elastic layer 68′ with an optically transparent fluid 84 in a reservoir 80 of pad 54′ to grip the work piece 52. In one embodiment, the fluid 84 includes suspended transparent granular materials with a refractive index matched to that of the fluid 84. In one embodiment, transparent polytetrafluoroethylene (PTFE) granules can be suspended in water or aqueous solutions. In another embodiment, polyvinylidene fluoride or polyvinylidene difluoride (PVDF) granules are suspended in an ethylene glycol based solution.

In the illustrated embodiment, contact pad 54′ includes a sheet 82 of transparent, flexible polymer such as ethylene tetrafluoroethylene (ETFE) which is constructed in conjunction with a transparent rigid base 66 to form a substantially closed reservoir 80 for elastic layer 68′. Sheet 82 includes diffraction markers 72′ having diffractive colorimetric properties to form diffraction layer 70′. In one embodiment, a mixture of transparent PVDF granules and an ethylene glycol—water solution which is index matched to the PVDF is injected into reservoir 80. An injection system 86 includes plumbing 88 in fluid contact with the reservoir 80 to enable fluid 84 to be extracted or injected from reservoir 80 to change the viewing angles. Fluid injection and extraction can be used to drive a jamming transition/relaxation of contact pad 54′ to provide gripping action when in contact with work piece 52.

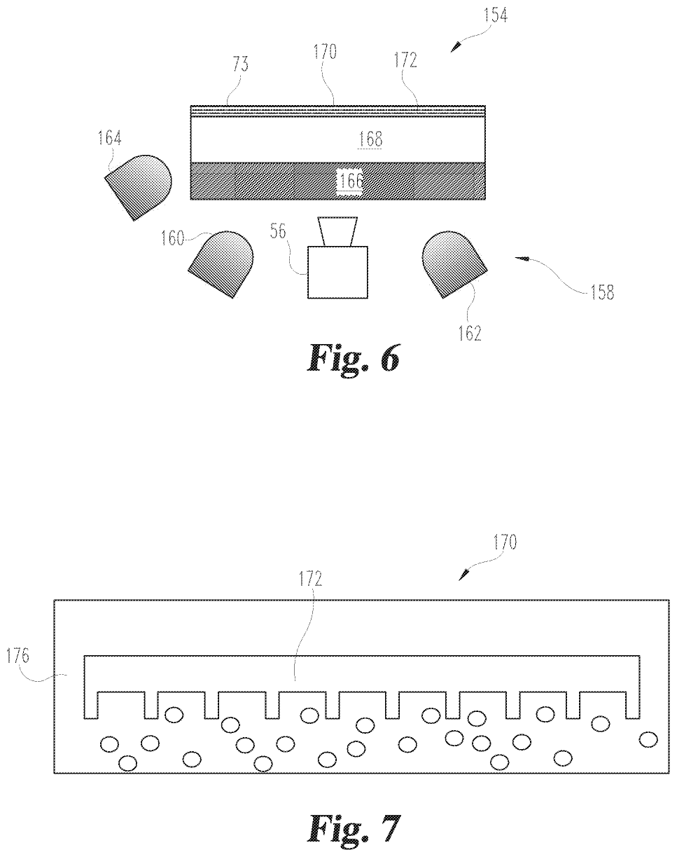

Referring to FIGS. 6-7, another embodiment visual-tactile contact pad 154 that can be employed in the device 50 is shown. In this embodiment, the diffraction layer 170 includes diffraction elements, such as one or more diffraction markers 172, in combination with fluorescent light emitters or fluorophores 174 that are located near or proximate the one or more diffraction markers 172, such as within a few wavelengths or less. In one embodiment, the fluorescent light emitters 174 are located within one wavelength or less of the diffraction marker(s) 172. In one embodiment, the fluorescence light emitters 174 are located within the near field of diffraction grating of the diffraction markers 172, such as within about a quarter wavelength. In this embodiment, the optical signal returned to the camera 56 for sensing by camera 56 is relatively independent of the incoming light source angle.

This arrangement may be achieved in various ways. In one embodiment the diffraction markers 172 are formed by a diffractive glitter powder, such as a holographic glitter or flakes. The diffraction markers 172 provide a diffractive metallic layer or grating, which is then overcoated by a stabilizing polymer layer 176 and dissolving fluorescent compounds into the polymer layer 176 to provide fluorescent light emitters 174.

The emission of light from the fluorescent light emitters 174 is typically more weakly dependent upon the incoming angle of the light from another embodiment lighting system 158 that includes ultraviolet lights 160, 162, 164. The light from lighting system 158 that excites fluorescent light emitters 174 provides a diffuse lighting condition that may be used to excite fluorescence. The outgoing angle of the light (which is also a function of wavelength) depends primarily on the angle of the diffraction surface to the camera 56 and is relatively independent of the angle of the diffraction surface to the exciting light.

In some embodiments, the fluorophore or fluorophores of fluorescent light emitters 174 used will be chosen to provide broad-band fluorescence so that the color of a large spectrum will report on the angle of the diffractive surface. In some embodiments, the spectrum of the excitation light will be chosen to be outside of the spectrum which is sensed by the camera 56 so that specular reflection effects are suppressed and colorimetric effects are more pronounced for sensing.

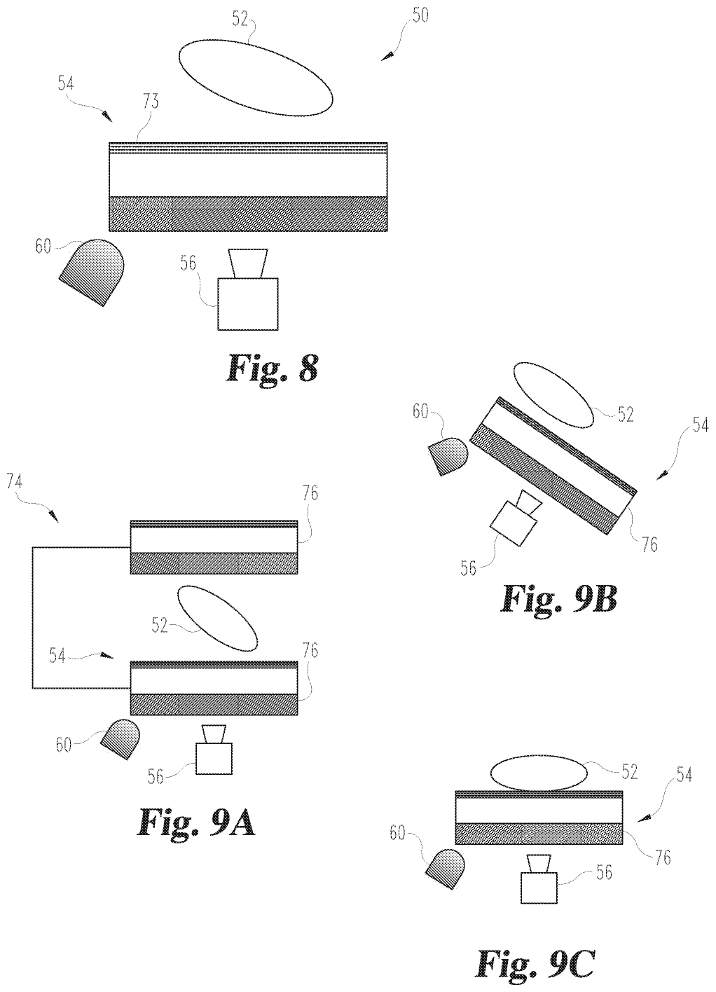

Referring to FIG. 8, another aspect of the present disclosure is provided. As discussed above the visual-tactile sensing device 50 utilizes a visual-tactile contact pad 54 that provides a deformable tactile sensor with “look through” capabilities. These look through capabilities enable dynamic optimization of the robotic gripper or other end effector incorporating the contact pad 54 as it approaches the work piece 52 to enable grip and conformation of the robotic gripper with respect to the work piece 52 prior to engagement by contact pad 54. The use of visual sensing at the outer surface 73 of the contact pad 54 enables high precision sensing and situational adaptation of the robot to situational specifics prior to contact with the work piece 50. This can allow higher speed operation and more successful operational outcomes.

Current robotics operations typically use some combination of preprogrammed coordinates or visual sensors which are placed at some distance from the end effector, and occasionally tactile sensing, to guide robotic motion. However, this often leads to imprecision in adapting to particular aspects of the work piece 52 which the end effector interacts with, such as the fine details of the work piece location and pose.

Incorporation of at-end-effector visual sensing of objects such as is provided by visual-tactile sensing device 50 and its look-through architectures can enable the robotic system to provide high-accuracy and precision for the robotic system to perceive the work piece 52. The ability to obtain high local accuracy and fidelity allows the position and pose of the robotic gripper to adapt to the specific situation to interact more effectively and efficiently with work piece 52 both prior to contact and during the contacting process.

The robotic gripper 74 can be used to image the work piece using any of the techniques described above with respect to the visual-tactile contact pad 54 and/or the gap between opposed contact pads, and if necessary a controller 64 can reconfigure the orientation of either or both of the work piece 52 or the gripper to provide for a better engagement between the two. Note that the contact pad 54 from FIGS. 8 and 9A-9C can also be used in any of the embodiments discussed herein. The embodiments disclosed in FIGS. 8 and 9A-9C are useful to make any of the determinations described herein (e.g. contact force, contact image, etc.) using any of the various embodiments described herein. The contact pad 54 illustrated in FIGS. 8 and 9A-9C may include a layer containing optical features which can also be transparent to the camera (e.g. diffraction markers, silver flakes, etc.), a fully transparent elastic layer supporting the optical features layer, and a rigid support (the elastic layer and the rigid support can take the form of those discussed above).

Such reconfiguring of the relative orientation between pad 54 and the work piece 52 can be performed prior to actual engagement, it can be after an initial engagement, and in some instances can occur during an engagement such as through the use of gripper motion (e.g. ‘rolling’ the work piece through manipulation of the fingers 76. The system can be constructed to receive information about the work piece 52 (using the techniques described above), determine an orientation of the work piece 52 based on the information, send commands to actuators to reposition the gripper 74 (and/or reposition the work piece 52 if it is being manipulated by other actuators), and subsequently grip the work piece 52 with the fingers 76.

If an undesirable grip is realized, the fingers (e.g. the actuators associated with movement of the fingers) can be commanded to release the work piece 52 so that the fingers 76 can be repositioned. In some situations the fingers 76 can be commanded to move while maintaining contact with the work piece 52 so as to re-orient the work piece 52 relative to the fingers 76.

In some embodiments the controller can have a preprogrammed image/model of the work piece 52, where a current image of the work piece 52 is compared against the preprogrammed image/model to determine a relative orientation between the work piece 52 and the fingers 76. The controller may have a preferred orientation of the work piece 52 and generate commands to the fingers 76 based upon the difference between the preferred orientation and the actual orientation.

A pre-contact image of the work piece 52 can be provided through any one, or more than one, of the visual-tactile contact pads associated with the robotic fingers. In some forms the work piece 52 can be imaged in a pre-contact state through any of the visual-tactile contact pads and through any gap provided in the system. As will be understood, in any of the embodiments herein the gap may simply be a sight of the camera to the work piece whether or not the sight exists in a gap between fingers. For example, a fiber optic cable can be routed from any advantageous position to the camera, where such position is not limited to between fingers of the robotic gripper.

In light of the embodiments described in FIGS. 8 and 9A-9C, incorporation of at-end-effector visual sensing of objects (especially based on look-through embodiments of the pads 54) can enable the robotic system to provide high-accuracy and precision for the robotic system to perceive the situation with high local accuracy and fidelity and can adjust the robotic system's position and pose to adapt to the specific situation to interact more effectively and efficiently. And for look-through pads 54 it enables the robotic system to adapt to the situation of the contacted object both prior to contact and during the contacting process (if the pose changes dynamically—e.g. for flexible contacting objects) and after contact has been fully achieved to fully characterize the pose and ALSO to be able to sense the contact forces between the gripper and the object. This enables the robot to operate more rapidly and to achieve higher operational success rate in each situation based on this high fidelity information of the local situation.

For example, in FIG. 9A the robotic gripper incorporating the sensing device 50 is brought into the vicinity of the work piece 52. In the illustrated pose, the grip will not be optimal, and this is visualized with camera 56 and light 60 imaging the orientation and pose of the work piece 52 through the contact pad 54. In FIG. 9B the robotic gripper 74 is reoriented prior to contact of the contact pad 54 with work piece 52 to optimize engagement while visualization through the contact pad 54 is provided. In FIG. 9C the robot gripper 74 can be further reoriented to provide optimal pose and/or positioning of the work piece 52 while the contact pad 54 is in engagement with the work piece 52 and visualization through contact pad 54 is provided.

One aspect of the present application includes an apparatus that is a visual-tactile sensing device structured to image a tactile impression of the work piece upon engagement of the work piece with a visual-tactile contact pad to develop tactile image data. The tactile sensing device includes a lighting system structured to emit light and a camera structured to image electromagnetic radiation associated with the light emitted from the lighting system. The visual-tactile contact pad includes a rigid base and an elastic layer coupled to the rigid base. The rigid base provides a structural support for the elastic layer. The visual-tactile contact pad also includes a diffraction layer structured to receive light from the lighting system. The diffraction layer is positioned adjacent the elastic layer such that the elastic layer is positioned between the rigid base and the diffraction layer. The elastic layer and diffraction layer of the visual-tactile contact pad are structured to deform upon engagement of the work piece with the visual-tactile contact pad. The tactile image data is generated in response at least in part to an apparent color emanating from the diffraction layer that is imaged by the camera upon engagement of the work piece to the visual-tactile contact pad.

In one embodiment, the rigid base is comprised of a polycarbonate material, and the elastic layer is comprised of PDMS. In one embodiment, the diffraction layer includes diffraction markers embedded in an elastic material.

In one refinement, the diffraction markers are comprised of a holographic foil. In another refinement, the diffraction markers are arranged so that diffraction is produced in a plane of a surface of the diffraction layer extending along the visual-tactile contact pad.

In another refinement, the diffraction markers are arranged so that diffraction is produced in a plane normal to a surface of the diffraction layer extending along the visual-tactile contact pad. In a further refinement, the diffraction markers include Xirallic type particles having a metal flake on one side.

In one embodiment, the light system includes two light sources. In one refinement of this embodiment, the two light sources are disposed at differential angular orientations relative to a surface of the diffraction layer extending along the visual-tactile contact pad diffraction marker. In a further refinement, a controller is structured to activate the two light sources in an alternating manner such that when a first light source of the two light sources is ON then a second light source of the two light sources is OFF, and vice versa.

Another aspect of the present application includes a method for operating a visual-tactile sensing device. The method includes emitting a light from a lighting system toward a visual-tactile contact pad of a robotic system. The robotic system includes a camera for imaging a work piece and contact of the work piece with the visual-tactile contact pad, and the visual-tactile contact pad includes a rigid base, an elastic layer, and a diffraction layer. The method further includes deforming the elastic layer and the diffraction layer upon engagement of the work piece with the visual-tactile contact pad; passing the light through the rigid base and the elastic layer coupled to the rigid base of the visual-tactile contact pad; diffracting the light in the diffraction layer to emanate an apparent color from the diffraction layer; sensing, with the camera, the apparent color of the light emanating from diffraction layer in response to the deforming; and determining a parameter associated with the deformed elastic layer and diffraction layer in response to the apparent color.

In one embodiment, emitting the light includes emitting light from a first light source of the lighting system and emitting light from a second light source of the lighting system. In a refinement of this embodiment, the first light source is arranged to emit light at an angle relative to the second light source. In another refinement, the first light source and the second light source are operated to emit light at a different timing from one another.

In another embodiment, the parameter includes a surface contour of the work piece. In another embodiment, emitting the light includes emitting the light in one of a spectral continuum and a discrete spectrum. In another embodiment, emitting the light includes at least one of: emitting the light via a single point light source, emitting the light via an annulus-shaped light source, and emitting the light via a collimated light source.

In another embodiment, the diffractions layer includes a plurality of diffraction markers. In one refinement of this embodiment, the diffraction markers are comprised of flakes of diffractive material embedded in a layer of elastic material. In a further refinement, the flakes are comprised of reflective diffractive grating material of holographic foil.

Yet another aspect of the present application provides a method comprising: imaging a work piece with a camera associated with a robotic gripper that includes a visual-tactile contact pad integrated with each of a plurality of fingers; determining an orientation of the work piece relative to a finger of the plurality of fingers of the robotic gripper; orienting the finger to position the work piece in a gripping position based on the determining; and gripping the work piece between a visual-tactile contact pad of the finger and another finger of the plurality of fingers at a desired force after the orienting.

An embodiment includes the imaging includes providing a pre-contact image of the work piece through the visual-tactile contact pad. Another embodiment includes the imaging includes providing a pre-contact image of the work piece through a gap provided between fingers of the robotic gripper. Another feature includes determining a contact force of the finger.

Yet another embodiment includes the another finger including a visual-tactile contact pad such that the work piece is positioned between visual-tactile contact pads of each of the fingers. Still yet another embodiment includes providing a pre-contact image of the work piece through the visual-tactile contact pads associated with the finger and the another finger.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected.

It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
a visual-tactile sensing device structured to image a tactile impression of the work piece upon engagement of the work piece with a visual-tactile contact pad to develop tactile image data, the tactile sensing device having:
a lighting system structured to emit light;
a camera structured to image electromagnetic radiation associated with the light emitted from the lighting system;
wherein the visual-tactile contact pad includes:
a rigid base;
an elastic layer coupled to the rigid base, the rigid base providing a structural support for the elastic layer; and
a diffraction layer structured to receive light from the lighting system, the diffraction layer positioned adjacent the elastic layer such that the elastic layer is positioned between the rigid base and the diffraction layer;
wherein the elastic layer and diffraction layer of the visual-tactile contact pad are structured to deform upon engagement of the work piece with the visual-tactile contact pad, wherein the tactile image data is generated in response at least in part to an apparent color emanating from the diffraction layer that is imaged by the camera upon engagement of the work piece to the visual-tactile contact pad.

2. The apparatus of claim 1, wherein the diffraction layer includes diffraction markers embedded in an elastic material.

3. The apparatus of claim 2, wherein the diffraction markers are comprised of a holographic foil.

4. The apparatus of claim 2, wherein the diffraction markers are arranged so that diffraction is produced in a plane of a surface of the diffraction layer extending along the visual-tactile contact pad.

5. The apparatus of claim 2, wherein the diffraction markers are arranged so that diffraction is produced in a plane normal to a surface of the diffraction layer extending along the visual-tactile contact pad.

6. The apparatus of claim 5, wherein the diffraction markers include Xirallic type particles having a metal flake on one side.

7. The apparatus of claim 1, wherein the light system includes two light sources.

8. The apparatus of claim 7, wherein the two light sources are disposed at differential angular orientations relative to a surface of the diffraction layer extending along the visual-tactile contact pad diffraction marker.

9. The apparatus of claim 8, which further includes a controller, and wherein the controller is structured to activate the two light sources in an alternating manner such that when a first light source of the two light sources is ON then a second light source of the two light sources is OFF, and vice versa.

10. A method of operating a visual-tactile sensing device, comprising:
emitting a light from a lighting system toward a visual-tactile contact pad of a robotic system, the robotic system including a camera for imaging a work piece and contact of the work piece with the visual-tactile contact pad, the visual-tactile contact pad including a rigid base, an elastic layer, and a diffraction layer;
deforming the elastic layer and the diffraction layer upon engagement of the work piece with the visual-tactile contact pad;
passing the light through the rigid base and the elastic layer coupled to the rigid base of the visual-tactile contact pad;
diffracting the light in the diffraction layer to emanate an apparent color from the diffraction layer;
sensing, with the camera, the apparent color of the light emanating from diffraction layer in response to the deforming; and
determining a parameter associated with the deformed elastic layer and diffraction layer in response to the apparent color.

11. The method of claim 10, wherein emitting the light includes emitting light from a first light source of the lighting system and emitting light from a second light source of the lighting system.

12. The method of claim 11, wherein the first light source is arranged to emit light at an angle relative to the second light source.

13. The method of claim 11, wherein the first light source and the second light source are operated to emit light at a different timing from one another.

14. The method of claim 10, wherein the parameter includes a surface contour of the work piece.

15. The method of claim 10, wherein emitting the light includes emitting the light in one of a spectral continuum and a discrete spectrum.

16. The method of claim 10, wherein emitting the light includes at least one of: emitting the light via a single point light source, emitting the light via an annulus-shaped light source, and emitting the light via a collimated light source.

17. The method of claim 10, wherein the diffractions layer includes a plurality of diffraction markers.

18. The method of claim 17, wherein the diffraction markers are comprised of flakes of diffractive material embedded in a layer of elastic material.

19. The method of claim 18, wherein the flakes are comprised of reflective diffractive grating material of holographic foil.

20. The method of claim 17, wherein the diffraction layer includes fluorescent light emitters proximate the diffraction markers and the lighting system includes one or more ultraviolet lights to excite the fluorescent light emitters.

21. A method comprising:
imaging a work piece with a camera associated with a robotic gripper that includes a visual-tactile contact pad integrated with each of a plurality of fingers;
determining an orientation of the work piece relative to a finger of the plurality of fingers of the robotic gripper;
orienting the finger to position the work piece in a gripping position based on the determining; and
gripping the work piece between a visual-tactile contact pad of the finger and another finger of the plurality of fingers at a desired force after the orienting.

22. The method of claim 21, wherein the imaging includes providing a pre-contact image of the work piece through the visual-tactile contact pad.

23. The method of claim 21, wherein the imaging includes providing a pre-contact image of the work piece through a gap provided between fingers of the robotic gripper.

24. The method of claim 21, which further includes determining a contact force of the finger.

25. The method of claim 21, wherein the another finger includes a visual-tactile contact pad such that the work piece is positioned between visual-tactile contact pads of each of the fingers.

26. The method of claim 25, wherein the imaging includes providing a pre-contact image of the work piece through the visual-tactile contact pads associated with the finger and the another finger.
